(19) United States
(12) Patent Application Publication
(10) Pub. No.: US 2025/0073508 A1
(43) Pub. Date: Mar. 6, 2025

(54) CONNECTION ASSEMBLY FOR A FALL PROTECTION SYSTEM

(71) Applicant: THE BOEING COMPANY, Arlington, VA (US)

(72) Inventors: Alexandru Gheorghe Badger, Stanwood, WA (US); David Anton Danner, JR., Snohomish, WA (US)

(73) Assignee: THE BOEING COMPANY, Arlington, VA (US)

(21) Appl. No.: 18/457,407

(22) Filed: Aug. 29, 2023

(51) Int. Cl. A62B 35/00; B66F 17/00

(52) U.S. Cl. CPC A62B 35/0075; A62B 35/0068; B66F 17/006

(57) ABSTRACT

A connection assembly for a fall protection system of a lift system. The connection assembly includes a connector including a shell housing and an inner sub-assembly. The inner sub-assembly is rotatable relative to the shell housing. A coupler is configured to be selectively connected to and disconnected from the connector, wherein the inner sub-assembly is configured to be rotated in relation to the shell housing to selectively connect the coupler to and disconnect the coupler from the connector.

### FIELD OF THE DISCLOSURE

Examples of the present disclosure generally relate to personal fall protection systems and methods, and more particularly, to a connection assembly for a fall protection system.

### BACKGROUND OF THE DISCLOSURE

Regulations exist that require individuals using a lift system (for example, a boom lift, a scissor lift, etc.) to wear a fall protection harness that is to be connected to the lift system. For example, if an occupant falls from the lift, the fall distance is limited by a length of a safety strap that extends between the protection harness worn by the operator and the lift basket. The safety strap may have a safety key disposed at one end of the strap (that is opposite the end of the strap that is tethered to the harness of the operator) that may be coupled with one or more safety anchors of the lift basket. The safety anchors may be electrically coupled with a control system of the lift system, and a verification process may require confirmation that each safety key is securely coupled with at least one safety anchor before movement of the lift system is allowed.

Known connection devices for fall protection connection systems may be difficult to attach or detach, such as if an individual is wearing gloves. In particular, gloves may interfere with manipulation and engagement of the safety equipment. In short, known connection devices may not allow for quick and easy manipulation to connect and disconnect.

### SUMMARY OF THE DISCLOSURE

A need exists for an improved connection device for a fall protection system. A need exists for a connection device that is easily and effectively manipulated by an individual. Further, a need exists for a connection device that can be easily and effectively grasped, engaged, and manipulated with gloves.

With those needs in mind, certain examples of the present disclosure provide a connection assembly for a fall protection system. The connection assembly includes a connector including a shell housing and an inner sub-assembly. The inner sub-assembly is rotatable relative to the shell housing. A coupler is configured to be selectively connected to and disconnected from the connector. The inner sub-assembly is configured to be rotated in relation to the shell housing to selectively connect the coupler to and disconnect the coupler from the connector.

In at least one example, the connector is configured to be coupled to a basket of a lift system, and the coupler is configured to be coupled to a safety harness worn by an individual.

As an example, the connector includes a support plate, a base cylinder coupled to the support plate, an intermediate disk coupled to the base cylinder, a pin disk coupled to the intermediate disk, a retaining plate coupled to the pin disk, and a cap coupled to the retaining plate.

The pin disk retains one or more pins. The pins are moveable in relation to the pin disk. The one or more pins have an end configured to move into and out of a reciprocal opening of the retaining plate. In at least one example, one or more springs are coupled to the one or more pins. The one or more springs bias the one or more pins into and through the reciprocal opening. In at least one example, the one or more pins include a protuberance extending outwardly through a track formed through the pin disk.

In at least one example, the shell housing includes a helical track. The protuberance includes at least a portion disposed within the helical track. The protuberance is moveable through the helical track.

In at least one example, the intermediate disk includes a button configured to be engaged to rotate the inner sub-assembly relative to the shell housing.

As an example, the coupler includes a main body configured to extend above the cap when the coupler is connected to the connector. One or more necks extend downwardly from the main body. One or more radial hooks connect to the one or more necks. The one or more radial hooks include a tip separated from the main body by a gap.

In at least one example, the inner sub-assembly comprises the pin disk and the intermediate disk.

Certain examples of the present disclosure provide a lift system including a basket configured to receive one or more passengers within an interior region, and a fall protection system including a connection assembly, as described herein.

### BRIEF DESCRIPTION OF THE DRAWINGS

FIG. 1 illustrates an isometric view of a lift system, according to an example of the present disclosure.

FIG. 2 illustrates a simplified top view of a passenger basket of a lift system, according to an example of the present disclosure.

FIG. 3 illustrates a schematic of a controller of the passenger basket shown in FIG. 2, according to an example of the present disclosure.

FIG. 4 illustrates a schematic of a lift system, according to an example of the present disclosure;

FIG. 5 illustrates a partial view of a safety key operably coupled with a safety anchor of a passenger basket, according to an example of the present disclosure.

FIG. 6 illustrates an isometric exploded view of a connection assembly for a fall protection system, according to an example of the present disclosure.

FIG. 7 illustrates an isometric view of a support plate disconnected from a base cylinder, according to an example of the present disclosure.

FIG. 8 illustrates an isometric view of an intermediate disk having a button, according to an example of the present disclosure.

FIG. 9 illustrates an isometric internal view of a pin within a pin disk, according to an example of the present disclosure.

FIG. 10 illustrates an isometric view of a connector, according to an example of the present disclosure.

FIG. 11 illustrates an isometric top view of a coupling aligned with openings of a cap of the connector, according to an example of the present disclosure.

FIG. 12 illustrates an isometric top view of the coupling connecting to the connector, according to an example of the present disclosure.

FIG. 13 illustrates an isometric top view of the coupling secured to the connector, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, examples of the present disclosure provide a connection assembly for a fall protection system. The connection assembly provides a quick attach connection system including a coupler and a connector configured to be selectively connected and disconnected from one another via a press and twist motion. The connection assembly can be easily connected or disconnected, even if an individual is wearing gloves.

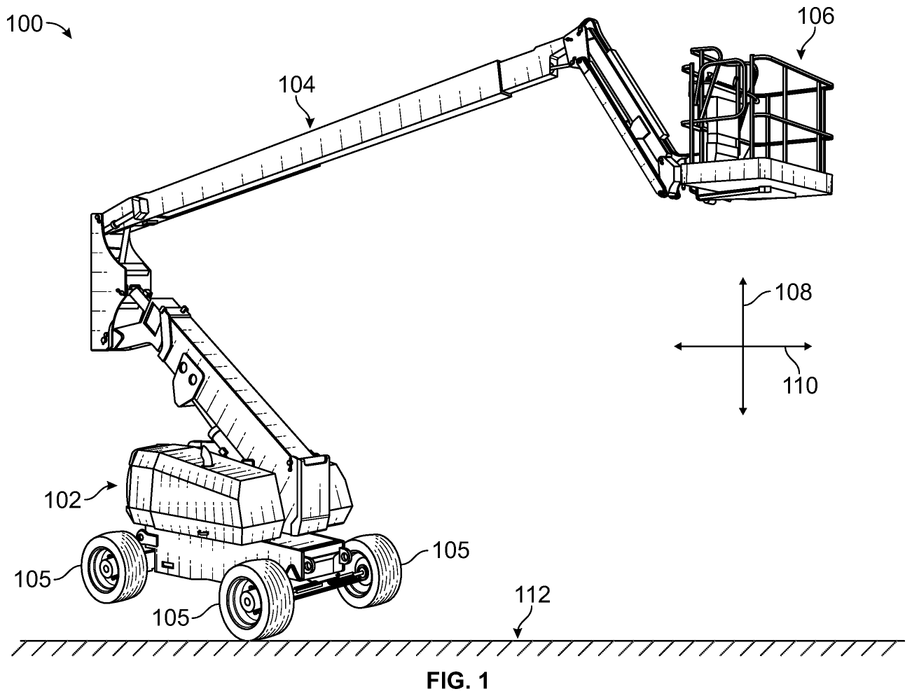

FIG. 1 illustrates an isometric view of a lift system 100, according to an example of the present disclosure. The lift system includes a base 102 and a passenger basket 106, with one or more arms 104 that extend between the base 102 and the basket 106. In other examples, the lift system 100 may be a scissor lift system, or the like, that moves occupants and/or equipment between different elevations. In the illustrated example, the lift system 100 is a boom lift system, and the arm(s) 104 is controlled to move the passenger basket 106 in a vertical direction 108 (between a ground surface 112 and different elevations), and a horizontal or lateral direction 110. Additionally, the base 102 can include wheels 105 that can be controlled to move the lift system 100 in the horizontal direction 110.

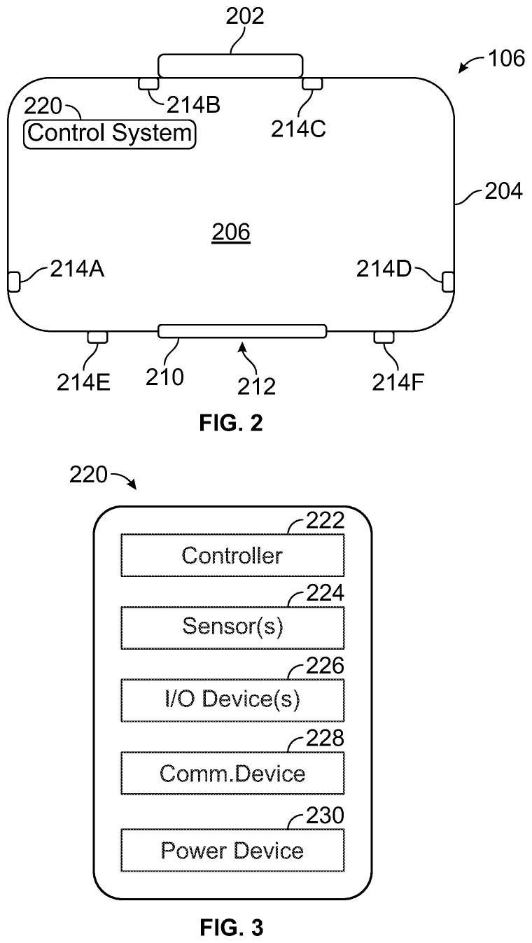

FIG. 2 illustrates a simplified top view of the passenger basket 106, in according to an example of the present disclosure. The passenger basket 106 includes a basket frame 204 that is coupled with the arm (not shown in FIG. 2) at a joint 202. The passenger basket 106 includes an interior region 206 that is inside of the basket frame 204. For example, one or more occupants and/or equipment may be positioned within the interior region 206 of the basket frame 204 to move the occupants and/or equipment to different elevations.

The passenger basket 106 includes a gate 210 that is arranged to move between an open position and a closed position (shown in FIG. 2) in a direction of rotation 212. In another example, the gate 210 may have an alternative arrangement such that the gate 210 moves in one or more different directions between the open and closed positions.

The lift system 100 also includes a control system 220. In the illustrated example, the control system 220 is positioned within the passenger basket 106, but in alternative examples, the control system 220, or one or more components of the control system 220, may be disposed at other locations of the lift system, such as at the base 102.

FIG. 3 illustrates a schematic of one example of the control system 220. The control system 220 includes a control unit or controller 222 having one or more processors, such as one or more microprocessors, field programmable gate arrays, integrated circuits, and/or the like. In one example, the controller 222 may include a single processor or multiple processors. All operations can be performed by each processor, or each processor may perform at least one different operation than one or more (or all) other processors.

In at least one example, the control system 220 includes one or more sensors 224. In one or more examples, the one or more sensors 224 may include a position sensor, a camera (e.g., a still camera, a video camera, an ergonomic camera, etc.), a pressure sensor, an ultrasonic sensor, a collision sensor, an infrared sensor, and/or the like. The one or more sensors 224 may be positioned at one or more locations of the passenger basket 106, may be operably coupled with the passenger basket 106, may be disposed outside of the basket 106, or any combination therein. In at least one example, the one or more sensors 224 may be referred to as occupant detector sensors. For example, the sensors 224 may sense or otherwise detect data associated with occupants and/or other loads (for example, equipment, materials, etc.) that are positioned within the passenger basket 106 such as, but not limited to, a number of occupants that are inside the basket 106, a location of each of the occupants within the interior region 206 of the passenger basket 106 (for example, relative to each other occupant, relative to the gate 210, etc.), a number of occupants that are disposed outside of the passenger basket 106 (for example, such as an occupant that has moved outside of the basket frame 204), a location of the equipment within the basket 106, a weight of the other loads, a total weight of the occupants and the other loads, and/or the like.

The control system 220 also includes one or more input and/or output devices 226 (shown as I/O Device(s) in FIG. 3). The lift system 100 (shown in FIG. 1) can be manually operated by receiving instruction signals from the input/output devices 226 that can represent a touchscreen, a joystick, a keyboard, a switch, a wheel, a microphone, a display, a monitor, a speaker, a light, or the like.

In one or more examples, the control system 220 also includes a communication device 228 that can include transceiving hardware (for example, antennas, wires, cables, modems, codecs, or the like) that can wirelessly communicate signals or communicate signals described herein via wired connections. The communication device 228 may communicate with the one or more occupants and/or operators positioned within the passenger basket 106, with one or more operators positioned proximate to the base 102 of the lift system 100, with one or more operators at a control center (not shown), and/or the like.

The control system 220 also includes a power device 230, that can be or include one or more batteries, fuel cells, or the like, that may provide power to one or more systems and/or components of the lift system 100 (for example, propulsion loads, auxiliary loads, etc.).

Returning again to FIG. 2, in one or more examples, the gate 210 may be moved from a closed position to an open position, such as to allow occupants and/or equipment to move into and/or out of the interior region 206 of the passenger basket 106. In one example, prior to the passenger basket 106 leaving the ground surface, or moving away from the ground surface, the gate 210 may be moved to a closed position, such as to contain the occupants and/or equipment within the interior region 206 of the passenger basket 106. In another example, after the passenger basket 106 has been moved to an elevated position (for example, to perform maintenance on a structure, such as a building, an aircraft system, utility equipment, or the like), the gate 210 may be moved to an open position to allow the occupants to move out of the interior region 206 of the passenger basket 106. For example, the occupant may need to move to a portion of a structure that is being repaired that is at a location that the passenger basket is unable to reach.

The passenger basket 106 also includes safety anchors 214A-E that are disposed at different locations around the basket frame 204. In the illustrated example, the passenger basket 106 includes four safety anchors 214A-D that are disposed at interior locations of the basket frame 204 (for example, within the interior region 206 of the passenger basket), and two safety anchors 214E-F that are disposed at exterior locations of the basket frame 204 (for example, outside of the basket frame). Each of the safety anchors 214A-F may be shaped and/or sized to receive a mating component, such as a safety key, that secures or anchors the one or more occupants to the passenger basket 106. For example, a first end of a safety strap or lanyard (not shown) may be operably coupled with at least one of the occupants (for example, attached to the occupant such as by a harness, a carabiner, or the like), and a second end of the safety strap may be operably coupled with a safety key.

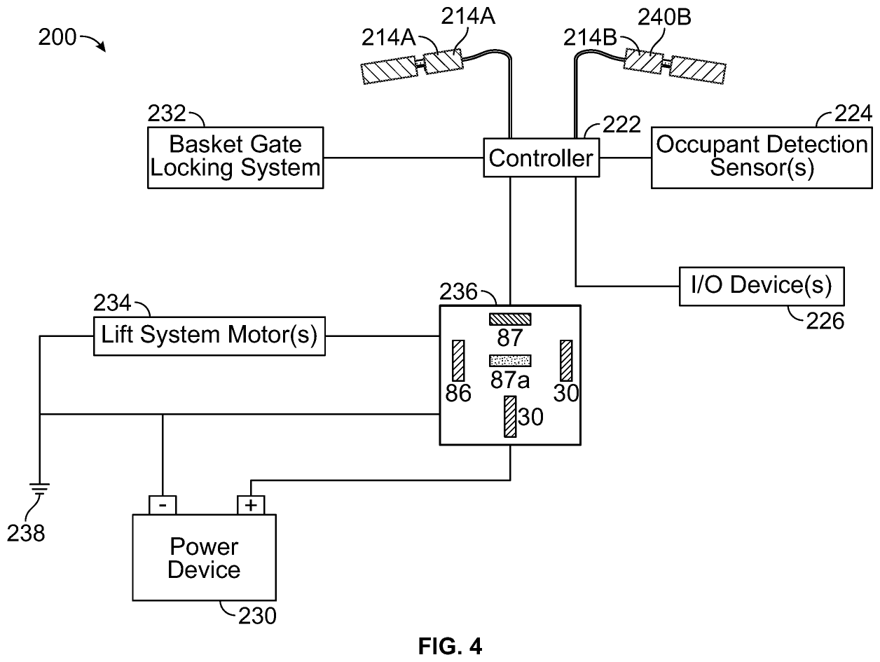

FIG. 4 illustrates a schematic of a lift system 200, according to an example of the present disclosure. The controller 222 is electrically coupled with the input/output device(s) 226, a locking system 232 of the basket gate (for example, an electronic and/or mechanical locking system that can control whether the gate can be opened and/or closed), the one or more sensors 224 (such as the occupant detector sensors), one or more lift system motors 234 (for example, motors that control movement of the passenger basket and/or the base 102 of the lift system 100), and the power device 230 via a relay 236. The one or more lift system motors 234, the power device 230, and the relay 236 are also electrically coupled with an electrical ground 238. The schematic shown in FIG. 4 is for illustrative purposes only. In another example, the lift system 200 have an alternative configuration, may include one or more additional electrical components, may be devoid one or more components shown, and/or the like.

In the illustrated example, the controller 222 is also electrically coupled with a first safety anchor 214A and a second safety anchor 214B. In other examples, the controller may be electrically coupled with three or more safety anchors of the passenger basket 106. The first safety anchor 214A is coupled with a first safety key 240A, and the second safety anchor 214B is coupled with a second safety key 240B.

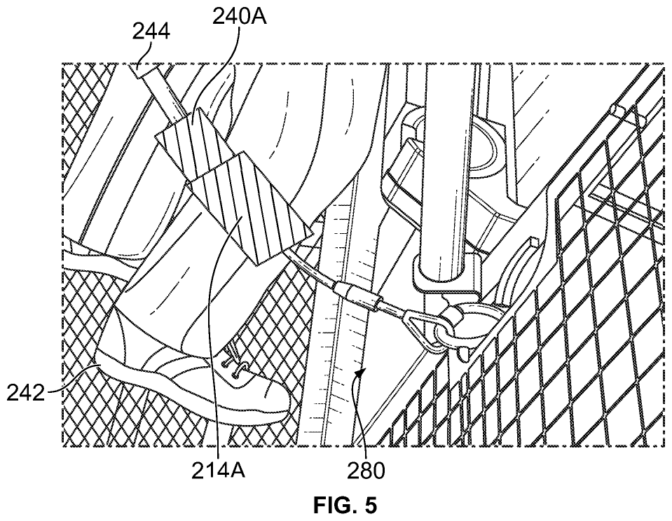

FIG. 5 illustrates a partial magnified view of the safety key 240A that is coupled with the first safety anchor 214A, according to an example of the present disclosure. Referring to FIGS. 1-5, the safety key 240A and the safety anchor 214 provide a connection assembly for a fall protection system 280 that is configured to prevent an individual from falling from the passenger basket 106 of the lift system 100. The safety key 240A is operably coupled with a first end of a safety strap 244 or safety lanyard. A second end of the safety strap 244 may be fastened or coupled with an occupant 242 of the passenger basket 106. While the occupant or operator is anchored to the safety anchor of the passenger basket 106 via the safety key 240A, the safety of the occupant increases relative to the occupant not being secured or tethered to the safety anchor via the safety key.

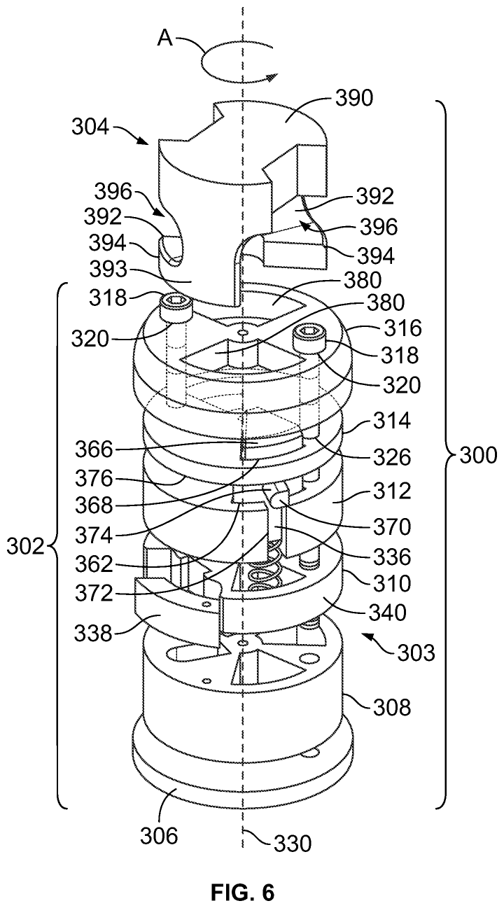

FIG. 6 illustrates an isometric exploded view of a connection assembly 300 for a fall protection system, according to an example of the present disclosure. The connection assembly 300 includes a connector 302 that is configured to removably retain a coupler 304. In at least one example, the connector 302 provides the safety anchor 214A shown in FIGS. 4 and 5, while the coupler 304 provides the safety key 240A shown in FIGS. 4 and 5.

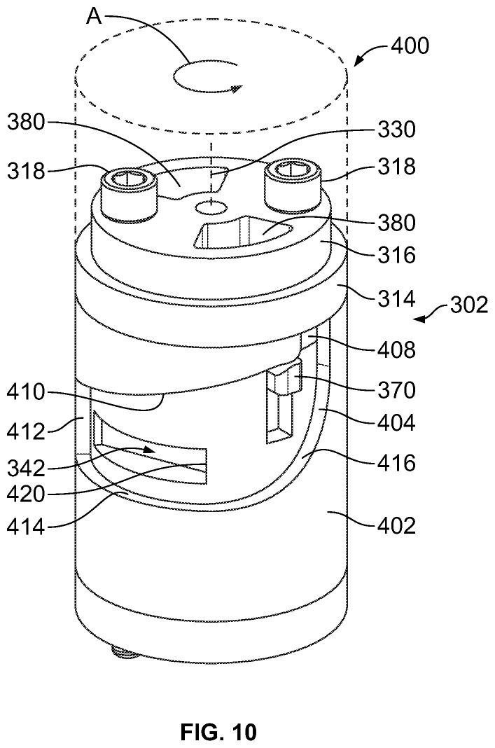

The connector 302 includes a support plate 306 coupled to a base cylinder 308, which, in turn, is coupled to an intermediate disk 310. A pin disk 312 is coupled to the intermediate disk 310. A retaining plate 314 is coupled to the pin disk 312. A cap 316 is coupled to the retaining plate 314. An inner sub-assembly 303 includes the pin disk 312 and the intermediate disk 310. As described herein, the inner sub-assembly 303 is configured to rotate relative to a shell housing 402 (shown in FIG. 10) to allow the coupler 304 to be selectively connected and disconnected form the connector 302.

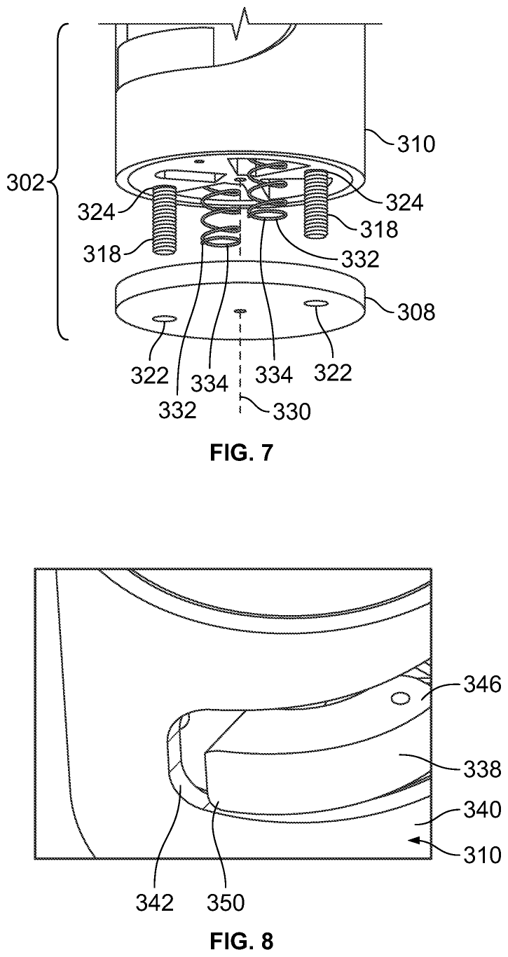

FIG. 7 illustrates an isometric view of the support plate 306 disconnected from the base cylinder 308, according to an example of the present disclosure. Referring to FIGS. 6 and 7, fasteners 318 extend from the cap 316 to the support plate 306 to secure the connector 302 together. The fasteners 318 can be screws, bolts, or the like. As shown, two fasteners 318 can be used. Optionally, a single fastener can be used, or three or more fasteners can be used. The fasteners 318 are retained by conforming through-holes 320 that pass through the cap 316, and conforming retaining recesses 322 formed in and/or passing through the support plate 306. In this manner, the cap 316 and the support plate 306 can be fixed in relation to one another. For example, the cap 316 may not rotate relative to the support plate 306. Similarly, the fasteners 318 pass through channels 324 that pass through the base cylinder 308. Further, the fasteners 318 pass through through-holes 326 formed in the retaining plate 314. As such, the cap 316, the support plate 306, the base cylinder 308, and the retaining plate 314 may remain fixed (for example, rotationally constrained) in relation to one another.

The fasteners 318 pass through open spaces formed within the intermediate disk 310 and the pin disk 312. As such, the intermediate disk 310 and the pin disk 312 can rotate a limited range about a longitudinal axis 330 of the connector 302.

As shown, springs 332 extend within the connector 302. The springs 332 have lower ends 334 that abut into the base cylinder 308. Ends (such as upper ends) opposite from the lower ends abut into pins 336 retained within the pin disk 312. For example, each spring 332 is coupled to a respective pin 336. FIG. 6 shows a pin 336. An additional pin 336 can also retained by the pin disk 312.

FIG. 8 illustrates an isometric view of the intermediate disk 310 having a button 338, according to an example of the present disclosure. The intermediate disk 310 includes a main body 340 having a radial channel 342 formed therein. The button 338 includes a pivot end 346 that is pivotally secured within the channel 342, such as by a connection fastener, such as a pin, (not shown), which can be spring-biased. The pivot end 346 connects to a free end 350 that can be selectively pressed inward. The spring-biased connection fastener outwardly biases the button 338 to be flush with an outer surface of the intermediate disk 310.

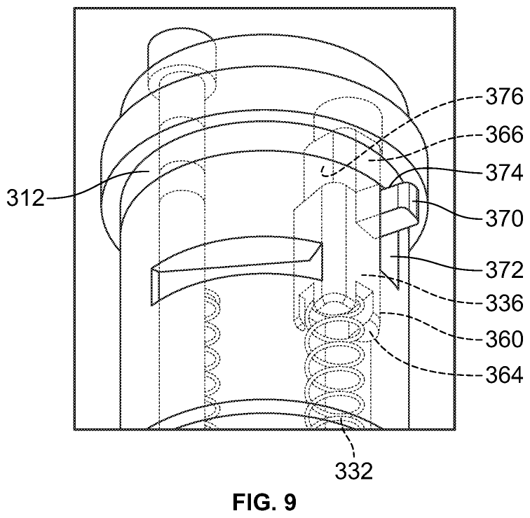

FIG. 9 illustrates an isometric internal view of a pin 336 within the pin disk 312, according to an example of the present disclosure. Referring to FIGS. 6 and 9, the pin 336 includes an extension body 360, which can be wedge shaped, and configured to be slidably retained within a conforming reciprocal opening 362 formed in the pin disk 312. The spring 332 abuts into a lower end 364 of the extension body 360 and acts to bias an end, such as an upper end 366, of the extension body 360 through a conforming reciprocal opening 368 of the retaining plate 314. The pin 336 also includes a protuberance 370, such as a post, barb, clasp, nub, or the like that extends outwardly from the extension body 360 and through a track 372 formed through the pin disk 312. When the spring 332 biases the upper end 366 of the extension body 360 through the opening 368 of the retaining plate 314, an upper surface 374 of the protuberance 370 abuts against a lower surface 376 of the retaining plate 314 to ensure that the pin 336 does not eject through the retaining plate 314.

Referring again to FIG. 6, the cap 316 includes opposed openings 380 formed therethrough. The coupler 304 includes a main body 390 that is configured to extend above the cap 316. Extension necks 392 extend downwardly from the main body 390. Each neck 392 connects to a radial hook 393 that radially extends below that main body 390. The radial hook 393 includes a tip 394 that extends below the main body 390, and is separated from the main body by a gap 396. The openings 380 are configured to conform to the shape of the hooks 393 and allow the hooks 393 to pass therethrough.

FIG. 10 illustrates an isometric view of the connector 302, according to an example of the present disclosure. The button 338 (shown in FIG. 8) is not shown in FIG. 10. As shown, the connector 302 has a cylindrical shape. That is, the connector 302 resides within a cylindrical envelope.

Referring to FIGS. 8 and 10, the button 338 is pivotally secured within the channel 342, such as by a connection fastener, such as a pin, (not shown), which can be spring-biased. The pivot end 346 connects to a free end 350 that can be selectively pressed inward. The spring-biased connection fastener outwardly biases the button 338 to be flush with an outer surface of the intermediate disk 310.

Referring to FIGS. 6 and 10, a shell housing 402 extends around the base cylinder 308, the intermediate disk 310, and the pin disk 312. That is, the connector 302 includes the shell housing 402. The shell housing 402 includes a helical track 404 formed therethrough. The helical track 404 includes an inlet 408 that extends to the retaining plate 314. The inlet 408 can be a straight segment defined by interior edges of the shell housing 402. The inlet 408 connects to an upper edge 410 that helically angles downwardly to a vertical edge 412. The vertical edge 412, in turn, connects to a lower ledge 414, which, in turn, connects to an upwardly curved edge 416 that connects to the inlet 408. As shown, the protuberance 370 abuts against the upper edge 410 proximate to the inlet 408.

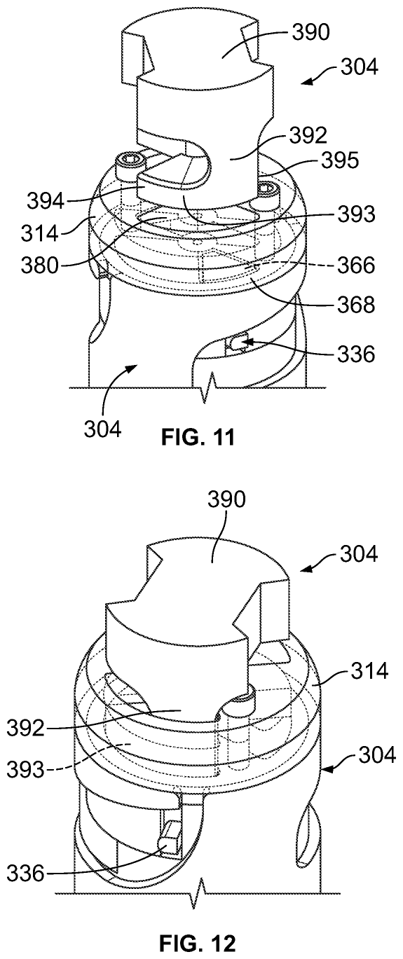

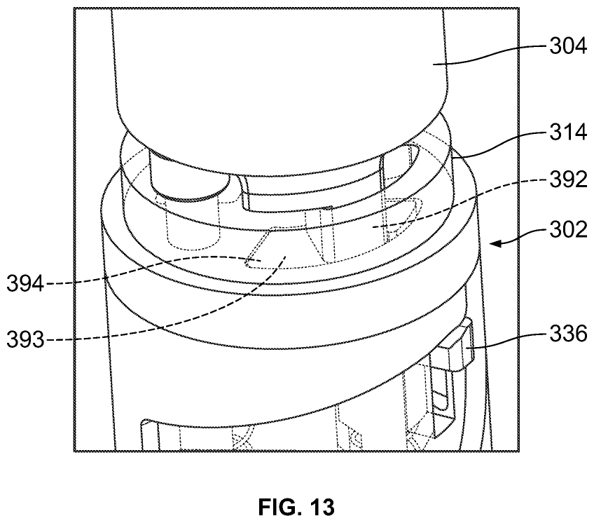

FIG. 11 illustrates an isometric top view of the coupler 304 aligned with the openings 380 of the cap 316 of the connector 302, according to an example of the present disclosure. FIG. 12 illustrates an isometric top view of the coupler 304 secured to the connector 302. FIG. 13 illustrates an isometric top view of the coupler 304 secured to the connector 302. Referring to FIGS. 6-13, in order to secure the coupler 304 to the connector 302, the hooks 393 of the coupling are axially aligned with the openings 380. The free end 350 of the button 338 is inwardly depressed with the pivot end 346 abutting into a wall 420 defining an end of the channel 342. An individual then rotates the intermediate disk 310 about the longitudinal axis 330 in the direction of arc A. During such rotational motion, the protuberance 370 slides underneath the upper edge 410 of the track, which pulls the pins 336 downwardly, thereby compressing the springs 332. Such rotational motion continues until the upper ends 366 of the pins 336 recede into the openings 368 of the retaining plate 314. Lower surfaces of the hooks 393 can then be positioned on the top surface of the retaining plate 314 over the recessed upper ends 366. The user may then release the button 338, and the force of the compressed springs 332 forces the intermediate disk 310 to rotationally retreat in a direction opposite from arc A. Optionally, the user may rotate the intermediate disk 310 in the direction opposite from arc A. Once the intermediate disk 310 rotates past the blunt ends 395 of the hooks 393, the upper ends 366 are forced upwardly through the openings 368 and abut against the blunt ends 395, with the tips 394 of the hooks 393 trapped underneath the retaining plate, thereby locking the coupler 304 to the connector 302. Such motion can also emit an audible click, thereby indicating that the coupler 304 is securely connected to the connector 302.

In order to disconnect the coupler 304 from the connector 302, a user may engage the button 338 to rotate the intermediate disk 310 relative to the shell housing 402 as described, so that the button retreats into the openings 368, and the hooks 393 axially align with the openings 380 of the cap 316. The coupler 304 can then be removed from the connector 302.

As described herein, examples of the present disclosure provide a connection assembly 300 for a fall protection system 280. The connection assembly 300 includes the connector 302 including the shell housing 402 and the inner sub-assembly 303. The inner sub-assembly 303 is rotatable relative to the shell housing 402. The coupler 304 is configured to be selectively connected and disconnected from the connector 302. The inner sub-assembly 303 is configured to be rotated in relation to the shell housing 402 (that is, the shell housing 402 can be manipulated and rotated in relation to the inner sub-assembly 303, or vice versa) to selectively connect the coupler 304 to and disconnect the coupler 304 from the connector 302.

As described herein, the connection assembly 300 includes the connector 302 and the coupler 304, which can be quickly, easily, and effectively selectively connected and disconnected from the connector 302 through rotational motion. It has been found that an individual wearing gloves, for example, can efficiently and effectively perform such operations.

In at least one example, the shell housing 402 is rotated relative to an inner sub-assembly 303 (or vice versa), which includes the intermediate disk 310 and the pin disk 312, for example. Such rotational motion retracts the pins 336, as described herein. A safety lanyard may be attached to the connector 302 or the coupler 304.

The cylindrical shape of the connector 302 allows for operation that is ergonomically improved in contrast to prior devices. Current known devices typically require intricate interaction in order to connect and disconnect components. In contrast, examples of the present disclosure provide easy-to-use components that can be selectively connected and disconnected from one another via simple rotational motion.

As described herein, examples of the present disclosure provide a method for a fall protection system of a lift system. The method includes connecting a coupler to a connector, and disconnecting the coupler from the connector by rotating an inner sub-assembly of the connector relative to the shell housing.

Further, the disclosure comprises examples according to the following clauses:

Clause 1: A connection assembly for a fall protection system, the connection assembly comprising:
a connector including a shell housing and an inner sub-assembly, wherein the inner sub-assembly is rotatable relative to the shell housing; and
a coupler configured to be selectively connected to and disconnected from the connector, wherein the inner sub-assembly is configured to be rotated in relation to the shell housing to selectively connect the coupler to and disconnect the coupler from the connector.

Clause 2. The connection assembly of Clause 1, wherein the connector is configured to be coupled to a basket of a lift system, and wherein the coupler is configured to be coupled to a safety harness worn by an individual.

Clause 3. The connection assembly of Clauses 1 or 2, wherein the connector comprises:
a support plate;
a base cylinder coupled to the support plate;
an intermediate disk coupled to the base cylinder;
a pin disk coupled to the intermediate disk;
a retaining plate coupled to the pin disk; and
a cap coupled to the retaining plate.

Clause 4. The connection assembly of Clause 3, wherein the pin disk retains one or more pins, wherein the pins are moveable in relation to the pin disk, and wherein the one or more pins have an end configured to move into and out of a reciprocal opening of the retaining plate.

Clause 5. The connection assembly of Clause 4, further comprising one or more springs coupled to the one or more pins, wherein the one or more springs bias the one or more pins into and through the reciprocal opening.

Clause 6. The connection assembly of Clauses 4 or 5, wherein the one or more pins comprise a protuberance extending outwardly through a track formed through the pin disk.

Clause 7. The connection assembly of Clause 6, wherein the shell housing comprises a helical track, wherein the protuberance includes at least a portion disposed within the helical track, and wherein the protuberance is moveable through the helical track.

Clause 8. The connection assembly of any of Clauses 3-7, wherein the intermediate disk comprises a button configured to be engaged to rotate the inner sub-assembly relative to the shell housing.

Clause 9. The connection assembly of any of Clauses 3-8, wherein the coupler comprises:
a main body configured to extend above the cap when the coupler is connected to the connector;
one or more necks extending downwardly from the main body; and
one or more radial hooks connecting to the one or more necks, wherein the one or more radial hooks comprise a tip separated from the main body by a gap.

Clause 10. The connection assembly of any of Clauses 3-9, wherein the inner sub-assembly comprises the pin disk and the intermediate disk.

Clause 11. A lift system comprising:
a basket configured to receive one or more passengers within an interior region;
a fall protection system including a connection assembly, the connection assembly comprising:
   a connector including a shell housing and an inner sub-assembly, wherein the inner sub-assembly is rotatable relative to the shell housing, and wherein the connector is coupled to a basket of a lift system; and
   a coupler configured to be selectively connected to and disconnected from the connector, wherein the coupler is configured to be coupled to a safety harness worn by an individual, and wherein the inner sub-assembly is configured to be rotated in relation to the shell housing to selectively connect the coupler to and disconnect the coupler from the connector.

Clause 12. The lift system of Clause 11, wherein the connector comprises:
a support plate;
a base cylinder coupled to the support plate;
an intermediate disk coupled to the base cylinder;
a pin disk coupled to the intermediate disk;
a retaining plate coupled to the pin disk; and
a cap coupled to the retaining plate.

Clause 13. The lift system of Clause 12, wherein the pin disk retains one or more pins, wherein the pins are moveable in relation to the pin disk, and wherein the one or more pins have an end configured to move into and out of a reciprocal opening of the retaining plate.

Clause 14. The lift system of Clause 13, wherein the connection assembly further comprises one or more springs coupled to the one or more pins, wherein the one or more springs bias the one or more pins into and through the reciprocal opening.

Clause 15. The lift system of Clauses 13 or 14, wherein the one or more pins comprise a protuberance extending outwardly through a track formed through the pin disk.

Clause 16. The lift system of Clause 15, wherein the shell housing comprises a helical track, wherein the protuberance includes at least a portion disposed within the helical track, and wherein the protuberance is moveable through the helical track.

Clause 17. The lift system of any of Clauses 12-16, wherein the intermediate disk comprises a button configured to be engaged to rotate the inner sub-assembly relative to the shell housing.

Clause 18. The lift system of Clause 17, wherein the coupler comprises: a main body configured to extend above the cap when the coupler is connected to the connector;
one or more necks extending downwardly from the main body; and
one or more radial hooks connecting to the one or more necks, wherein the one or more radial hooks comprise a tip separated from the main body by a gap.

Clause 19. The lift system of any of Clauses 12-19, wherein the inner sub-assembly comprises the pin disk and the intermediate disk.

Clause 20. A connection assembly for a fall protection system, the connection assembly comprising:
a connector including a shell housing and an inner sub-assembly, wherein the inner sub-assembly is rotatable relative to the shell housing, wherein the shell housing comprises a helical track, and wherein the connector is configured to be coupled to a basket of a lift system, wherein the connector further comprises:
   a support plate;
   a base cylinder coupled to the support plate;
   an intermediate disk coupled to the base cylinder, wherein the intermediate disk comprises a button configured to be engaged to rotate the inner sub-assembly relative to the shell housing;
   a pin disk coupled to the intermediate disk, wherein the pin disk retains one or more pins, and wherein the pins are moveable in relation to the pin disk, wherein the one or more pins comprise a protuberance extending outwardly through a track formed through the pin disk, wherein the protuberance includes at least a portion disposed within the helical track, and wherein the protuberance is moveable through the helical track;
   one or more springs coupled to the one or more pins, wherein the one or more springs bias the one or more pins into and through the reciprocal opening;
   a retaining plate coupled to the pin disk, wherein the one or more pins have an end configured to move into and out of a reciprocal opening of the retaining plate; and
   a cap coupled to the retaining plate; and
a coupler configured to be selectively connected to and disconnected from the connector, wherein the coupler is configured to be coupled to a safety harness worn by an individual, wherein the inner sub-assembly is configured to be rotated in relation to the shell housing to selectively connect the coupler to and disconnect the coupler from the connector, and wherein the coupler comprises:
   a main body configured to extend above the cap when the coupler is connected to the connector;
   one or more necks extending downwardly from the main body; and
   one or more radial hooks connecting to the one or more necks, wherein the one or more radial hooks comprise a tip separated from the main body by a gap.

As described herein, examples of the present disclosure provide an improved connection device for a fall protection system. Examples of the present disclosure provide a connection assembly that is easily and effectively manipulated by an individual. Further, examples of the present disclosure provide a connection assembly that can be easily and effectively grasped, engaged, and manipulated with gloves.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A connection assembly for a fall protection system, the connection assembly comprising:
a connector including a shell housing and an inner sub-assembly, wherein the inner sub-assembly is rotatable relative to the shell housing; and
a coupler configured to be selectively connected to and disconnected from the connector, wherein the inner sub-assembly is configured to be rotated in relation to the shell housing to selectively connect the coupler to and disconnect the coupler from the connector.

2. The connection assembly of claim 1, wherein the connector is configured to be coupled to a basket of a lift system, and wherein the coupler is configured to be coupled to a safety harness worn by an individual.

3. The connection assembly of claim 1, wherein the connector comprises:
a support plate;
a base cylinder coupled to the support plate;
an intermediate disk coupled to the base cylinder;
a pin disk coupled to the intermediate disk;
a retaining plate coupled to the pin disk; and
a cap coupled to the retaining plate.

4. The connection assembly of claim 3, wherein the pin disk retains one or more pins, wherein the pins are moveable in relation to the pin disk, and wherein the one or more pins have an end configured to move into and out of a reciprocal opening of the retaining plate.

5. The connection assembly of claim 4, further comprising one or more springs coupled to the one or more pins, wherein the one or more springs bias the one or more pins into and through the reciprocal opening.

6. The connection assembly of claim 4, wherein the one or more pins comprise a protuberance extending outwardly through a track formed through the pin disk.

7. The connection assembly of claim 6, wherein the shell housing comprises a helical track, wherein the protuberance includes at least a portion disposed within the helical track, and wherein the protuberance is moveable through the helical track.

8. The connection assembly of claim 3, wherein the intermediate disk comprises a button configured to be engaged to rotate the inner sub-assembly relative to the shell housing.

9. The connection assembly of claim 3, wherein the coupler comprises:
a main body configured to extend above the cap when the coupler is connected to the connector;
one or more necks extending downwardly from the main body; and
one or more radial hooks connecting to the one or more necks, wherein the one or more radial hooks comprise a tip separated from the main body by a gap.

10. The connection assembly of claim 3, wherein the inner sub-assembly comprises the pin disk and the intermediate disk.

11. A lift system comprising:
a basket configured to receive one or more passengers within an interior region;
a fall protection system including a connection assembly, the connection assembly comprising:
a connector including a shell housing and an inner sub-assembly, wherein the inner sub-assembly is rotatable relative to the shell housing, and wherein the connector is coupled to a basket of a lift system; and
a coupler configured to be selectively connected to and disconnected from the connector, wherein the coupler is configured to be coupled to a safety harness worn by an individual, and wherein the inner sub-assembly is configured to be rotated in relation to the shell housing to selectively connect the coupler to and disconnect the coupler from the connector.

12. The lift system of claim 11, wherein the connector comprises:
a support plate;
a base cylinder coupled to the support plate;
an intermediate disk coupled to the base cylinder;
a pin disk coupled to the intermediate disk;
a retaining plate coupled to the pin disk; and
a cap coupled to the retaining plate.

13. The lift system of claim 12, wherein the pin disk retains one or more pins, wherein the pins are moveable in relation to the pin disk, and wherein the one or more pins have an end configured to move into and out of a reciprocal opening of the retaining plate.

14. The lift system of claim 13, wherein the connection assembly further comprises one or more springs coupled to the one or more pins, wherein the one or more springs bias the one or more pins into and through the reciprocal opening.

15. The lift system of claim 13, wherein the one or more pins comprise a protuberance extending outwardly through a track formed through the pin disk.

16. The lift system of claim 15, wherein the shell housing comprises a helical track, wherein the protuberance includes at least a portion disposed within the helical track, and wherein the protuberance is moveable through the helical track.

17. The lift system of claim 12, wherein the intermediate disk comprises a button configured to be engaged to rotate the inner sub-assembly relative to the shell housing.

18. The lift system of claim 17, wherein the coupler comprises:
a main body configured to extend above the cap when the coupler is connected to the connector;
one or more necks extending downwardly from the main body; and
one or more radial hooks connecting to the one or more necks, wherein the one or more radial hooks comprise a tip separated from the main body by a gap.

19. The lift system of claim 12, wherein the inner sub-assembly comprises the pin disk and the intermediate disk.

20. A connection assembly for a fall protection system, the connection assembly comprising:
a connector including a shell housing and an inner sub-assembly, wherein the inner sub-assembly is rotatable relative to the shell housing, wherein the shell housing comprises a helical track, and wherein the connector is configured to be coupled to a basket of a lift system, wherein the connector further comprises:
a support plate;
a base cylinder coupled to the support plate;
an intermediate disk coupled to the base cylinder, wherein the intermediate disk comprises a button configured to be engaged to rotate the inner sub-assembly relative to the shell housing;
a pin disk coupled to the intermediate disk, wherein the pin disk retains one or more pins, and wherein the pins are moveable in relation to the pin disk, wherein the one or more pins comprise a protuberance extending outwardly through a track formed through the pin disk, wherein the protuberance includes at least a portion disposed within the helical track, and wherein the protuberance is moveable through the helical track;
one or more springs coupled to the one or more pins, wherein the one or more springs bias the one or more pins into and through the reciprocal opening;
a retaining plate coupled to the pin disk, wherein the one or more pins have an end configured to move into and out of a reciprocal opening of the retaining plate; and
a cap coupled to the retaining plate; and
a coupler configured to be selectively connected to and disconnected from the connector, wherein the coupler is configured to be coupled to a safety harness worn by an individual, wherein the inner sub-assembly is configured to be rotated in relation to the shell housing to selectively connect the coupler to and disconnect the coupler from the connector, and wherein the coupler comprises:
a main body configured to extend above the cap when the coupler is connected to the connector;
one or more necks extending downwardly from the main body; and
one or more radial hooks connecting to the one or more necks, wherein the one or more radial hooks comprise a tip separated from the main body by a gap.
